(19) United States
(12) Patent Application Publication
(10) Pub. No.: US 2025/0258115 A1
(43) Pub. Date: Aug. 14, 2025

(54) SYSTEM AND METHOD FOR CABINET RADIOGRAPHY UTILIZING X-RAY FLUORESCENCE

(71) Applicant: KUB Technologies Inc. DBA KUBTEC, Stratford, CT (US)

(72) Inventors: Vikram Butani, Fairfield, CT (US); Chester Lowe, Palm Springs, CA (US)

(73) Assignee: KUB Technologies Inc. DBA KUBTEC, Stratford, CT (US)

(21) Appl. No.: 19/051,356

(22) Filed: Feb. 12, 2025

Related U.S. Application Data
(60) Provisional application No. 63/552,660, filed on Feb. 12, 2024.

(51) Int. Cl. G01N 23/2204; G01N 9/24; G01N 23/223

(52) U.S. Cl. CPC G01N 23/2204; G01N 9/24; G01N 23/223

(57) ABSTRACT

A cabinet x-ray image system for obtaining x-ray fluorescence images of a specimen or sample includes a cabinet defining an interior chamber where the cabinet includes a walled enclosure surrounding the interior chamber, a door configured to cover the interior chamber and a sampling chamber for containing the specimen, a display, an x-ray fluorescence system including an x-ray source, a crystal, focusing coils or collimators, a fluorescence detector, a specimen platform, and a controller configured to selectively energize the x-ray source to emit x-rays through the specimen to the crystal and then through the focusing coils or collimators to the x-ray fluorescence detector, control the x-ray fluorescence detector to collect a spectra of the specimen when the x-ray source is energized, and control the focusing coils or collimators.

### FIELD

The present disclosure relates to the field of a cabinet X-ray incorporating a system and method for utilizing an x-ray tube with corresponding detector to perform x-ray fluorescence in a cabinet.

### BACKGROUND

X-ray fluorescence (XRF) is the emission of characteristic “secondary” (or fluorescent) X-rays from a material that has been excited by being bombarded with high-energy X-rays or gamma rays. The phenomenon is widely used for elemental analysis and chemical analysis, particularly in the investigation of metals, glass, ceramics and building materials, and for research in geochemistry, forensic science, archaeology and art objects such as paintings.

When materials are exposed to short-wavelength X-rays or to gamma rays, ionization of their component atoms may take place. Ionization consists of the ejection of one or more electrons from the atom, and may occur if the atom is exposed to radiation with an energy greater than its ionization energy. X-rays and gamma rays can be energetic enough to expel tightly held electrons from the inner orbitals of the atom. The removal of an electron in this way makes the electronic structure of the atom unstable, and electrons in higher orbitals “fall” into the lower orbital to fill the hole left behind. In falling, energy is released in the form of a photon, the energy of which is equal to the energy difference of the two orbitals involved. Thus, the material emits radiation, which has energy characteristic of the atoms present. The term fluorescence is applied to phenomena in which the absorption of radiation of a specific energy results in the re-emission of radiation of a generally lower different energy.

In energy-dispersive analysis, dispersion and detection occur as a single operation. Proportional counters or various types of solid-state detectors (PIN diode, Si(Li), Ge(Li), Silicon Drift Detector SDD) are used. They all share the same detection principle: An incoming X-ray photon ionizes a large number of detector atoms with the amount of charge produced being proportional to the energy of the incoming photon. The charge is then collected and the process repeats itself for the next photon. Detector speed is obviously critical, as all charge carriers measured have to come from the same photon to measure the photon energy correctly. Peak length discrimination may be used to eliminate events that seem to have been produced by two X-ray photons arriving almost simultaneously. The spectrum is then built up by dividing the energy spectrum into discrete bins and counting the number of pulses registered within each energy bin. EDXRF detector types vary in resolution, speed and the means of cooling (a low number of free charge carriers is critical in the solid state detectors): proportional counters with resolutions of several hundred eV cover the low end of the performance spectrum, followed by PIN diode detectors, while the Si(Li), Ge(Li) and SDDs occupy the high end of the performance scale.

In wavelength-dispersive analysis, the single-wavelength radiation produced by the monochromator is passed into a photomultiplier (a detector similar to a Geiger counter) which counts individual photons as they pass through. The counter is a chamber containing a gas that is ionized by X-ray photons. A central electrode is charged at (typically)+1700 V with respect to the conducting chamber walls, and each photon triggers a pulse-like cascade of current across this field. The signal is amplified and transformed into an accumulating digital count. These counts are then processed to obtain analytical data.

### SUMMARY

In at least one aspect, the disclosed embodiments are directed to a cabinet x-ray image system for obtaining x-ray fluorescence images of a specimen or sample, the system including a cabinet defining an interior chamber wherein the cabinet comprises a walled enclosure surrounding the interior chamber, a door configured to cover the interior chamber and a sampling chamber for containing the specimen, a display, an x-ray fluorescence system including an x-ray source, a crystal, focusing coils or collimators, a fluorescence detector, a specimen platform, and a controller configured to selectively energize the x-ray source to emit x-rays through the specimen to the crystal and then through the focusing coils or collimators to the x-ray fluorescence detector, control the x-ray fluorescence detector to collect a spectra of the specimen when the x-ray source is energized; and control the focusing coils or collimators.

The x-ray source may be a conventional, mini-focus, or micro-focus x-ray source.

The detector may be anything that fits within the confines of the cabinet;

The specimen platform may be configured to hold excised tissue, organ or bone specimens.

The specimen platform may be configured hold any organic or inorganic specimen or sample.

The cabinet x-ray image system may further include an optical camera configured to capture an optical image of the specimen, and the controller may be further configured to control the optical camera system to capture and collect the optical image of the specimen, and selectively display a spectral analysis image and an optical image of the specimen on the display.

The spectral analysis image and the optical image of the specimen may be displayed overlaid.

The x-ray source may be configured to emit a first amount of x-rays, the x-ray detector may include a plurality of pixels in an array, each pixel configured to detect a second amount of x-rays received by the pixel, and the controller may be further configured to create the density x-ray image from the plurality of pixels by comparing from the first amount of x-rays and the second amount of x-rays for each pixel in the array.

The different areas of the specimen or sample of the spectral x-ray image may be displayed in different grey scale, different color or different shades of color.

In another aspect, the disclosed embodiments are directed to a method for obtaining x-ray images and colorized or grey scale density x-ray images of a specimen using a cabinet x-ray image system, wherein the cabinet x-ray image system includes a cabinet defining an interior chamber wherein the cabinet comprises a walled enclosure surrounding the interior chamber, a door configured to cover the interior chamber and a sampling chamber for containing the specimen, a display, an x-ray system including an x-ray source, a photon-counting detector, and a specimen platform, and a controller, wherein the method incudes using the controller to selectively energize the x-ray source to emit x-rays through the specimen to the x-ray detector, control the x-ray detector to collect a projection x-ray image of the specimen when the x-ray source is energized, determine the density of different areas of the specimen from data collected from the x-ray detector of the projection x-ray image of the specimen when the x-ray source is energized, create a density x-ray image of the specimen wherein the different areas of the specimen are indicated as a density or range of densities based on the determined density of different areas of the specimen, and selectively display the density x-ray image of the specimen on the display.

The cabinet x-ray image system may further include an optical camera configured to capture an optical image of the specimen, and the method may further include using the controller to control the optical camera system to capture and collect the optical image of the specimen, and selectively display the density x-ray image and the optical image of the specimen on the display.

The spectral x-ray image and the optical image of the specimen may be displayed overlaid.

The present disclosure relates to the field of a cabinet X-ray incorporating an X-ray tube, a crystal, and an x-ray fluorescence detector for the production of spectra of a given sample. The computing device receives video data from the fluorescence detector and determines the composition of the specimen based on the captured x-ray photon data. This facilitates and aids the user in determining the composition of the sample. In particular, the disclosure relates to a system and method with corresponding apparatus for capturing an X-ray fluorescence image utilizing a crystal and a fluorescence detector allowing a cabinet X-ray unit to attain x-ray spectral data and minimize secondary radiation for easier distinction.

The systems and methods of embodiments of the present disclosure also address unmet needs by providing X-ray fluorescence analysis and techniques that may include optical imaging for imaging specimens that overcome the shortfall of the data received from smaller imaging systems alone.

With a cabinet unit incorporating a system and method of utilizing X-ray fluorescence, the researcher can utilize the resultant image to expeditiously visualize the multitude of densities/composition of the specimen/sample placed in the fully shielded cabinet and not risk radiation scatter nor exposure presenting an incorrect analysis of the sample/specimen.

A major advantage for utilizing a cabinet system is that the fluorescence process is inefficient, and the secondary radiation is much weaker than the primary beam. Furthermore, the secondary radiation from lighter elements is of relatively low energy (long wavelength) and has low penetrating power, and is severely attenuated if the beam passes through air for any distance. Because of this, for high-performance analysis, the path from tube to sample to detector is normally maintained under vacuum (around 10 Pa residual pressure). This means in practice that most of the working parts of the instrument have to be located in a large vacuum chamber. The problems of maintaining moving parts in vacuum, and of rapidly introducing and withdrawing the sample without losing vacuum, pose major challenges for the design of the instrument. For less demanding applications, or when the sample is damaged by a vacuum (e.g. a volatile sample), a helium-swept X-ray chamber can be substituted, with some loss of low-Z (Z=atomic number) intensities.

These cabinet systems are usually utilized for coating thickness and materials analysis offer rapid quality control and validation testing for PCB, semiconductor, electronics and metal finishing.

Coating measurement and materials analysis based on micro x-ray fluorescence (SRF) is a widely accepted and industry-proven analytical technique, offering ease of use, fast non-destructive analysis, requiring little to no sample preparation, capability of analysing solids or liquids over a wide element range from the periodic table.

### BRIEF DESCRIPTION OF THE DRAWINGS

Reference will now be made to the figures wherein like structures will be provided with like reference designations. It is understood that the drawings are diagrammatic and schematic representations of exemplary embodiments of the disclosure and are not limiting of the present disclosure nor are they necessarily drawn to scale. The Figures depict various features and uses of embodiments of the present disclosure, which embodiments are generally directed to a system that can utilize an X-ray tube, crystal, and x-ray fluorescence detector all mounted in a cabinet.

The patent or application file contains at least one drawing executed in color. Copies of this patent or patent application publication with color drawing(s) will be provided by the Office upon request and payment of the necessary fee.

To further clarify the above and other advantages and features of the present disclosure, a more particular description of the disclosure will be rendered by reference to specific embodiments thereof that are illustrated in the appended drawings. It is appreciated that these drawings depict only typical embodiments of the disclosure and are therefore not to be considered limiting of its scope. The disclosure will be described and explained with additional specificity and detail through the use of the accompanying drawings in which:

FIG. 1 schematically illustrates an exemplary embodiment of a system incorporating aspects of the present disclosure depicting orientation of an X-ray source, specimen, and digital detector as viewed when a door of a cabinet of the system is open.

FIG. 2 displays an example of an X-ray Cabinet System incorporating aspects of the present disclosure.

FIG. 3 illustrates a schematic arrangement of an exemplary wavelength dispersive spectrometer

FIG. 4 shows an exemplary spectrometer with a crystal and primary and secondary collimators according to embodiments of the present disclosure;

FIG. 5 depicts resulting K-Beta Mainline and V2C spectra after exposure to x-ray fluorescence utilizing exemplified embodiments of the present disclosure.

FIG. 6 illustrates an Energy Dispersant Spectroscopy (EDS) spectrum of a mineral crust of a vent shrimp (Rimicaris exoculate) after exposure to x-ray fluorescence.

FIG. 7 shows the basic components of a processing unit with a detector input, a processor, memory, I/O, and system control;

FIGS. 8A and 8B show properties of crystals that may be utilized in implementation of the disclosed embodiments;

FIGS. 9A and 9B illustrate wavelengths of various elements on the elemental chart;

FIGS. 10A-10D and 11A-11D illustrate examples of utilizing different wavelengths to attenuate trace metals in a leaf; and

FIGS. 12A-12C illustrate gray scale and colorized images obtained via spectroscopy according to the disclosed embodiments.

### DETAILED DESCRIPTION

In general, aspects of this disclosure include a device (cabinet X-ray system) utilizing an X-ray Fluorescence (XRF) system to measure coating thickness and material analysis for rapid quality control and validation testing in real-time of a sample or specimen.

X-ray fluorescence (XRF) is the emission of characteristic “secondary” (or fluorescent) X-rays from a material that has been excited by being bombarded with high-energy X-rays or gamma rays. The phenomenon is widely used for elemental analysis and chemical analysis, particularly in the investigation of metals, glass, ceramics and building materials, and for research in geochemistry, forensic science, archaeology and art objects such as paintings.

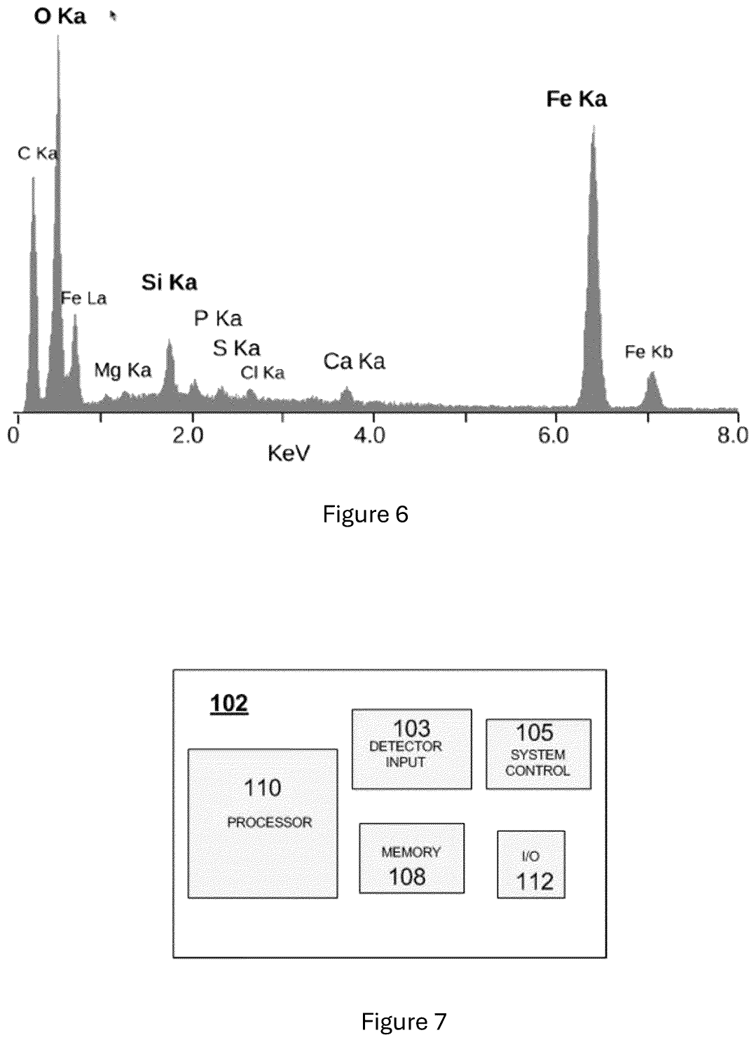

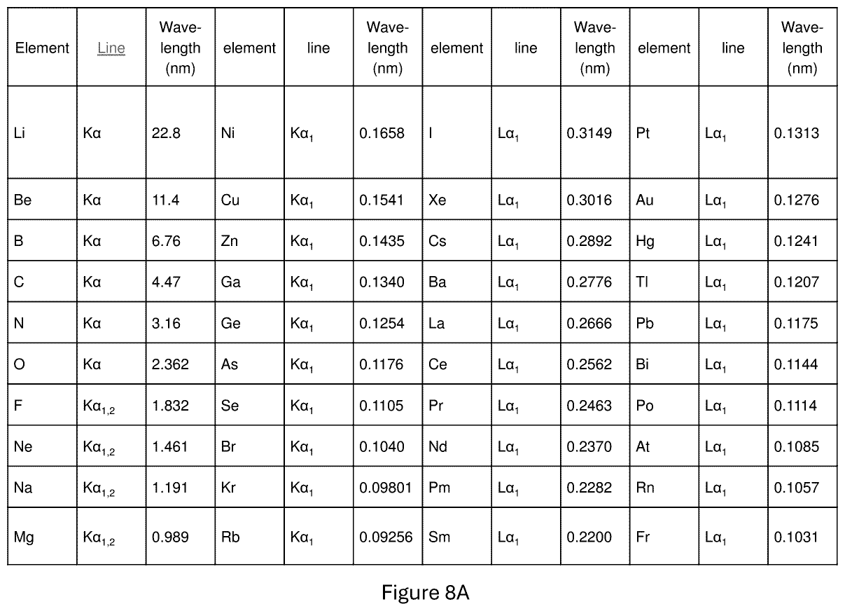

Another mode or method is Energy-dispersive X-ray Spectroscopy (EDS, EDX, EDXS or XEDS), sometimes called energy dispersive X-ray analysis (EDXA or EDAX) or energy dispersive X-ray microanalysis (EDXMA), which is an analytical technique used for the elemental analysis or chemical characterization of a sample. It relies on an interaction of some source of X-ray excitation and a sample. Its characterization capabilities are due in large part to the fundamental spectroscopy principle that each element has a unique atomic structure allowing a unique set of peaks on its electromagnetic emission spectrum, as shown in FIGS. 5 and 6. The peak positions are predicted by the Moseley's law with accuracy much better than experimental resolution of a typical EDX instrument.

To stimulate the emission of characteristic X-rays from a specimen, a beam of electrons or X-ray is focused into the sample being studied. At rest, an atom within the sample contains ground state (or unexcited) electrons in discrete energy levels or electron shells bound to the nucleus. The incident beam may excite an electron in an inner shell, ejecting it from the shell while creating an electron hole where the electron was. An electron from an outer, higher-energy shell then fills the hole, and the difference in energy between the higher-energy shell and the lower energy shell may be released in the form of an X-ray. The number and energy of the X-rays emitted from a specimen can be measured by an energy-dispersive spectrometer. As the energies of the X-rays are characteristic of the difference in energy between the two shells and of the atomic structure of the emitting element, EDS allows the elemental composition of the specimen to be measured.

The present disclosure and embodiments included therein can relate to specimen radiography but the disclosure is not isolated to specimen radiography but may be utilized, for example, for non-destructive testing, pathology as well as the X-ray fluorescence analysis of organic and non-organic samples or specimens, requiring a cabinet X-ray system but is not limited to just X-ray fluorescence but micro x-ray fluorescence and for any x-ray tube, crystal, or detector fitting within the confines of the cabinet X-ray system.

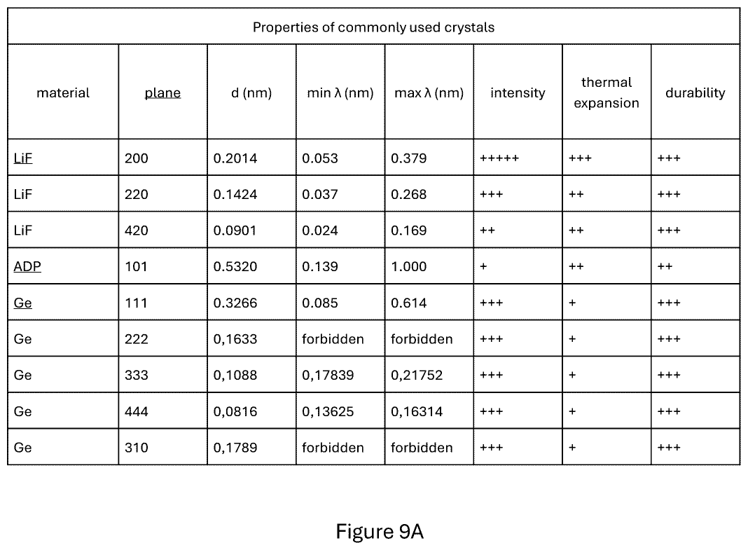

FIGS. 8A and 8B show properties of crystals that may be utilized in implementation of the disclosed embodiments. Crystals with simple structures tend to give the best diffraction performance. Crystals containing heavy atoms can diffract well, but also fluoresce more in the higher energy region, causing interference. Crystals that are water-soluble, volatile or organic tend to give poor stability.

Commonly used crystal materials include LiF (lithium fluoride), ADP (ammonium dihydrogen phosphate), Ge (germanium), Si (silicon), graphite, InSb (indium antimonide), PE (tetrakis-(hydroxymethyl)-methane, also known as pentaerythritol), KAP (potassium hydrogen phthalate), RbAP (rubidium hydrogen phthalate) and TIAP (thallium (I) hydrogen phthalate). In addition, there is an increasing use of “layered synthetic microstructures” (LSMs), which are “sandwich” structured materials comprising successive thick layers of low atomic number matrix, and monatomic layers of a heavy element. These can in principle be custom-manufactured to diffract any desired long wavelength, and are used extensively for elements in the range Li to Mg.

Detectors used for wavelength dispersive spectrometry need to have high pulse processing speeds in order to cope with the very high photon count rates that can be obtained. In addition, they need sufficient energy resolution to allow filtering-out of background noise and spurious photons from the primary beam or from crystal fluorescence. Common types of detectors may include, for example, gas flow, proportional counters, sealed gas detectors, and scintillation counters.

As used herein, the term “computer,” “computer system”, or “processor” refers to any suitable device operable to accept input, process the input according to predefined rules, and produce output, including, for example, a server, workstation, personal computer, network computer, wireless telephone, personal digital assistant, one or more microprocessors within these or other devices, or any other suitable processing device with accessible memory.

The term “computer program” or “software” refers to any non-transitory machine-readable instructions, program or library of routines capable of executing on a computer or computer system including computer readable program code.

The terms “camera” or “optical camera” refer to an instrument, including an optical instrument for capturing images in black and white, gray scale, or color using reflected and/or emitted wavelengths of the electromagnetic spectrum, for example, visible light or fluorescent light, from an object, similar to a photograph or that which could be viewed by a human eye, using an electronic light-sensitive sensor array. These terms may include such instruments producing images in standard resolution or high definition as well as a digital camera that can directly capture and store an image in computer-readable form using an array of electronic light-sensitive elements—typically semiconductor photo-sensors—that produce a light-intensity-dependent electronic signal in response to being illuminated.

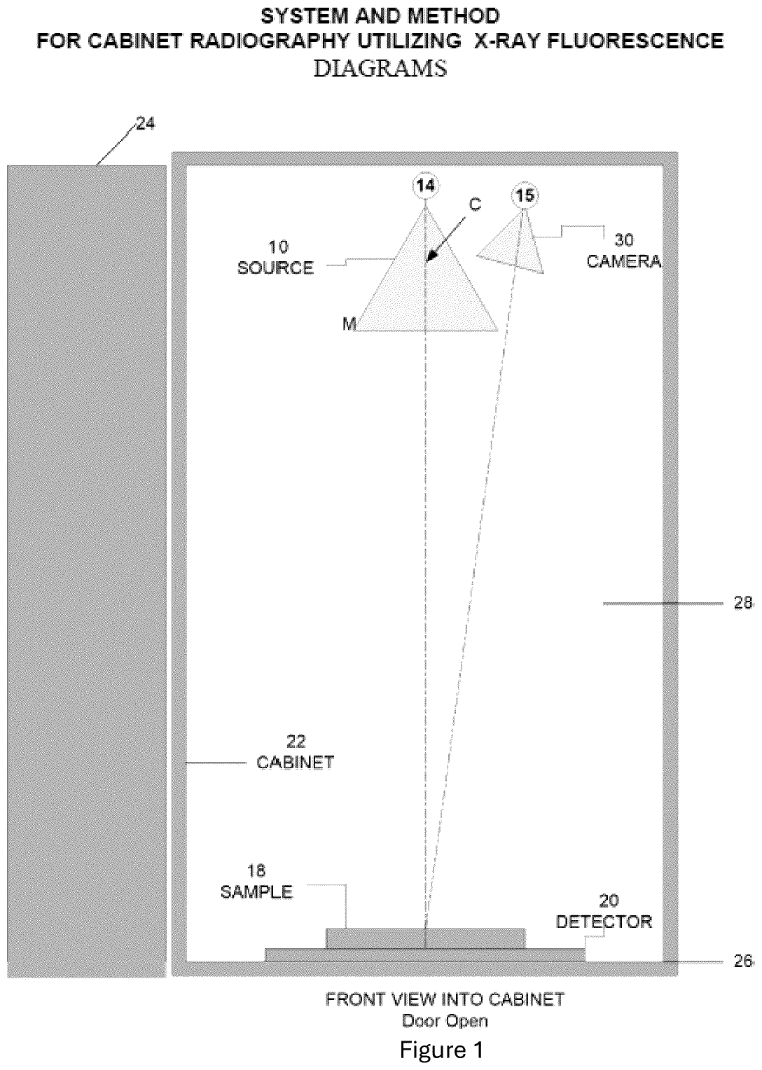

FIG. 1 schematically illustrates one embodiment with the orientation of the X-ray source 10 as seen when the door 24 is opened, and where the X-ray source 10 is located at approximately 0°, reference point 14 in this example, within the X-ray cabinet 22. In this embodiment, the motion of the X-ray source 10 can generally occur from the back to the front of the X-ray cabinet 22 with the detector 20 oriented, or otherwise disposed, at the base 26 of the X-ray cabinet 22, within the X-ray cabinet chamber 28. In one embodiment, the detector 20 is suitably coupled to the base 26 of the X-ray cabinet 22. The X-ray spread in this example can be from about 0 kVp to about 50 kVp with the system possibly utilizing an AEC (Automatic Exposure Control) to ascertain the optimal setting to image the object or sample 18 being examined.

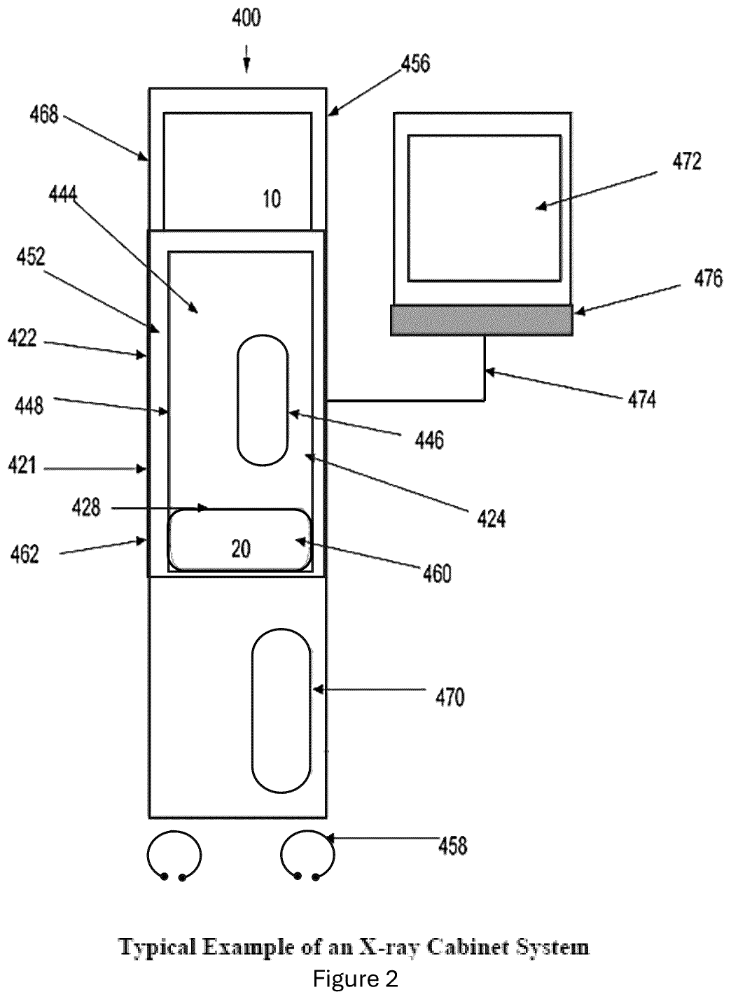

In one embodiment, the detector 20 and X-ray source 10 are controlled via a combination of one or more of software and hardware, such as non-transitory machine-readable instructions stored in a memory that are executable by one or more processors. On example of such a configuration can include controller cards of a computer 470 (FIG. 2), such as a MS Windows based computer. In one embodiment, non-transitory machine readable instructions being executed by one or more processors of the computer 470 are utilized to compile data received from the detector 20 and present resulting images to a suitable display or monitor 472. The detector 20 generates the respective digital values for the pixels in a two-dimensional array. The size of detector 20 may range, for example, from about 5.08 centimeters by 5.08 centimeters to about 40.64 centimeters by 40.64 centimeters, preferably about 12.7 centimeters by 8.24 centimeters. In one example, detector 20 has a rectangular array of approximately 836×1944 pixels with a pixel size of 74.8 micrometers. The resulting image dataset may be processed either at the full spatial resolution of detector 20 or at a lower spatial resolution by overlapping or binning a specified number of pixels in a single combined pixel value.

For example, binning occurs at a 2×2 ratio, then there would be an effective spatial resolution of approximately 149.6 micrometers. This binning may be achieved within the original programming of the detector 20 or within the computer 470 providing the spectral compilation and image.

FIG. 2 shows one embodiment of an X-ray Cabinet System 400 incorporating aspects of the present disclosure. In this embodiment, the X-ray Cabinet System 400 is mounted on wheels 458 to allow easy portability. In alternate embodiments, the X-ray Cabinet System 400 can be mounted on any suitable base or transport mechanism. The cabinet 422 in this example, similar to the exemplary X-ray cabinet 22 of FIG. 1, is constructed of a suitable material such as steel. In one embodiment, the cabinet 422 comprises painted steel defining a walled enclosure with an opening or cabinet chamber 428. Within the cabinet chamber 428, behind door 424, resides an interior space forming a sample chamber 444, which in this example is constructed of stainless steel. Access to the sample chamber 444 is via an opening 446. In one embodiment, the opening 446 of the sample chamber 444 has a suitable door or cover, such as a moveable cover 448. In one embodiment, the moveable cover 448 comprises a door which has a window of leaded glass.

Between the outer wall 421 of cabinet 422 and the sample chamber 444 are sheets of lead 452 that serve as shielding to reduce radiation leakage emitted from the X-ray source 10. In the example of FIG. 2, the X-ray source 10 is located in the upper part 456 of the cabinet 422, in the source enclosure 468. The detector 20 is housed in the detector enclosure 460 at an approximate midpoint 462 of the cabinet 422.

In one embodiment, a controller or computer 470 controls the collection of data from the detector 20, may control a swing arm and X-ray source 10. A monitor 472 displays the compiled data and can, for example, be mounted on an articulating arm 474 that is attached to the cabinet 422. The computer 470 receives commands and other input information entered by the operator via a user interface 476, such as a keyboard and mouse for example. In one embodiment, the computer 470 can comprise a touch screen or near touch screen device. Although the aspects of the disclosed embodiments will generally be described with respect to a computer 470, it will be understood that the computer 470 can comprise any suitable controller or computing device. Such computing devices can include, but are not limited to, laptop computers, minicomputers, tablets and pad devices.

The computer 470 can be configured to communicate with the components of the X-ray cabinet system 400 in any suitable manner, including hardwired and wireless communication. In one embodiment, the computer 470 can be configured to communicate over a network, such as a Local Area Network or the Internet.

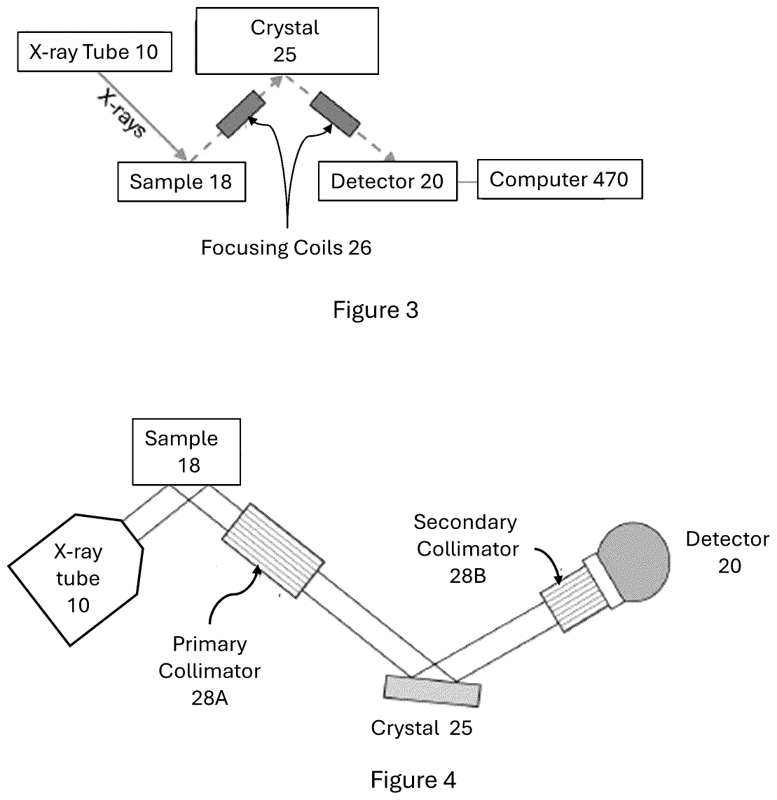

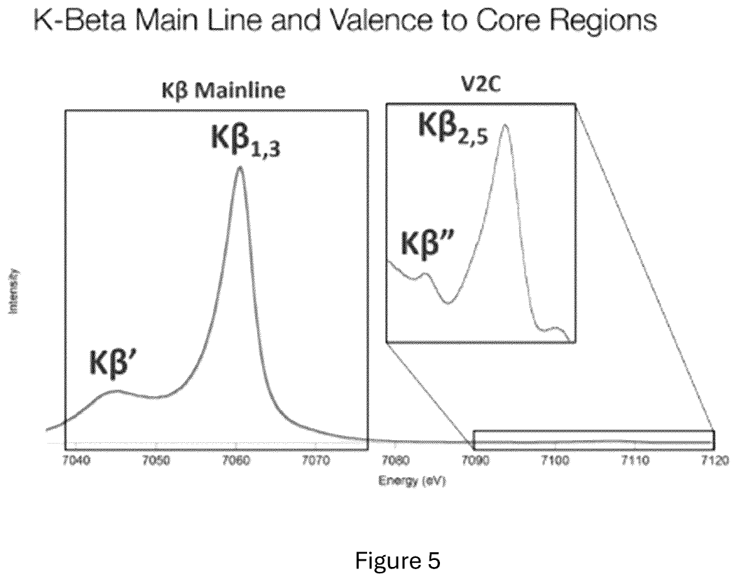

FIGS. 3 and 4 depict various features of embodiments of the present disclosure, which embodiments are generally directed to a system that can utilize different crystals and/or different focal spots of x-ray sources.

Referring to FIG. 3, there is shown the interconnection of an embodiment of an exemplary spectrometer with the x-ray tube 10 projecting a beam to the sample 18 which then reflects to the crystal 25 which then reflects via focusing coils 26 to the detector 20 which is interconnected to the computer 470.

Referring to FIG. 4, there is shown the interconnection of an embodiment of an exemplary spectrometer with the x-ray tube 10 projecting a beam to the sample 18 which then reflects to the crystal 25 which then reflects via primary and secondary collimators 28A, 28B, for example, Soller collimators, to the detector 20 which is interconnected to the computer 470.

In the disclosed embodiments, the x-ray tube 10 may have a standard focal spot, for example, 50 micron, or a micro-focus focal spot, for example, 5 microns.

FIGS. 5 and 6 show resulting spectra after exposure to x-ray fluorescence.

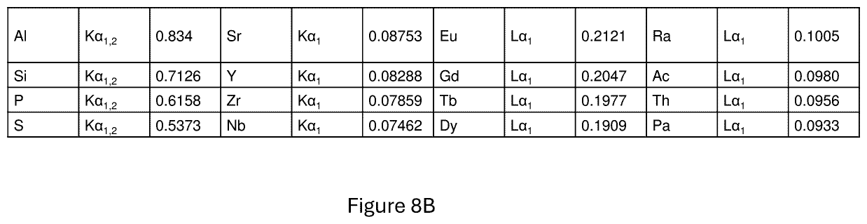

FIG. 7 shows the basic components of a processing unit 102 with data coming from the detector 103 proceeding to the processor 110 and memory 108 via the I/O 112 which also proceeds to a system control 105

FIGS. 8A and 8B shows the spectral frequencies of different crystals.

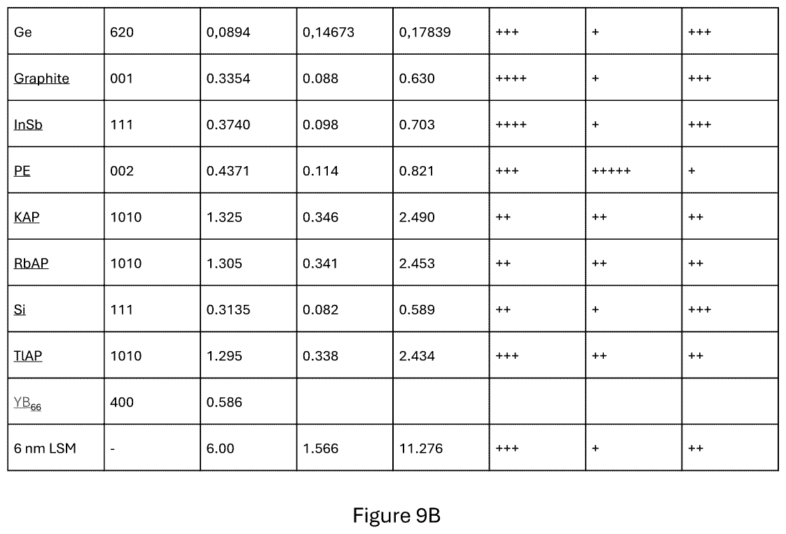

FIGS. 9A and 9B show various properties, including wavelengths, of elements that may be used to implement the disclosed embodiments.

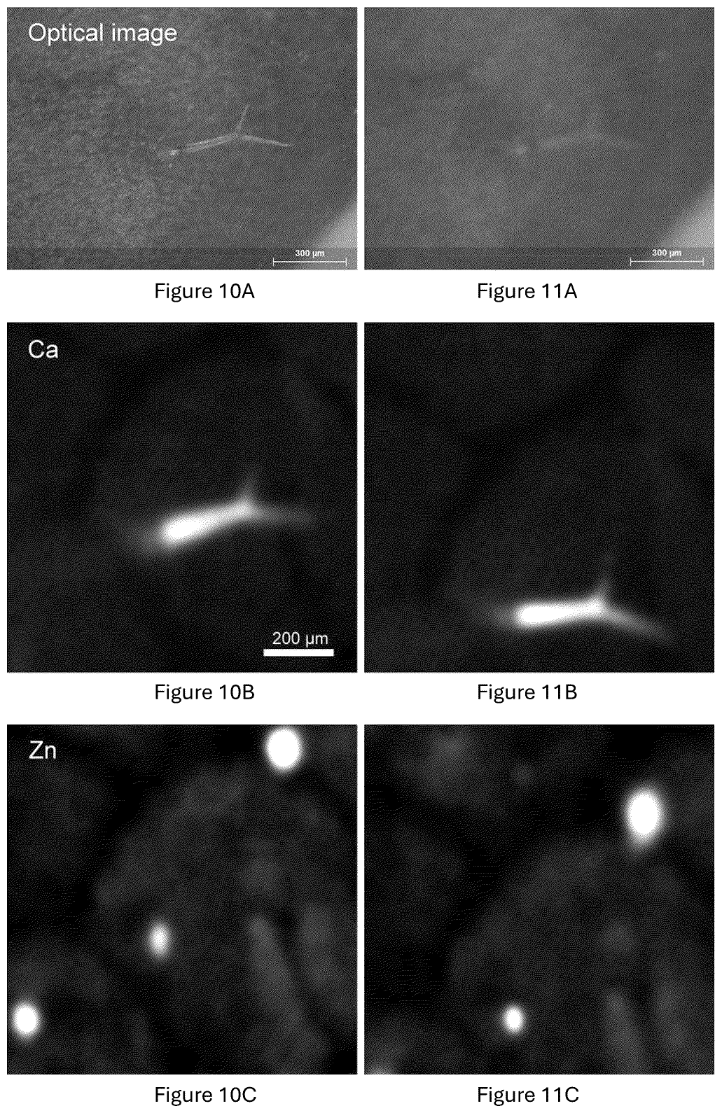

FIG. 10A shows an example of an optical image of a leaf, FIG. 10B shows a spectral analysis image of the result of utilizing a CA-Calcium wavelength to attenuate trace metals in the leaf, and FIG. 10C shows a spectral analysis image of the result of using a Zn-Zinc wavelength to attenuate trace metals in the leaf.

FIG. 10D illustrates the spectral analysis image of 10B and the optical image of 10A wherein the spectral analysis image of 10B and the optical image of 10A are displayed overlaid.

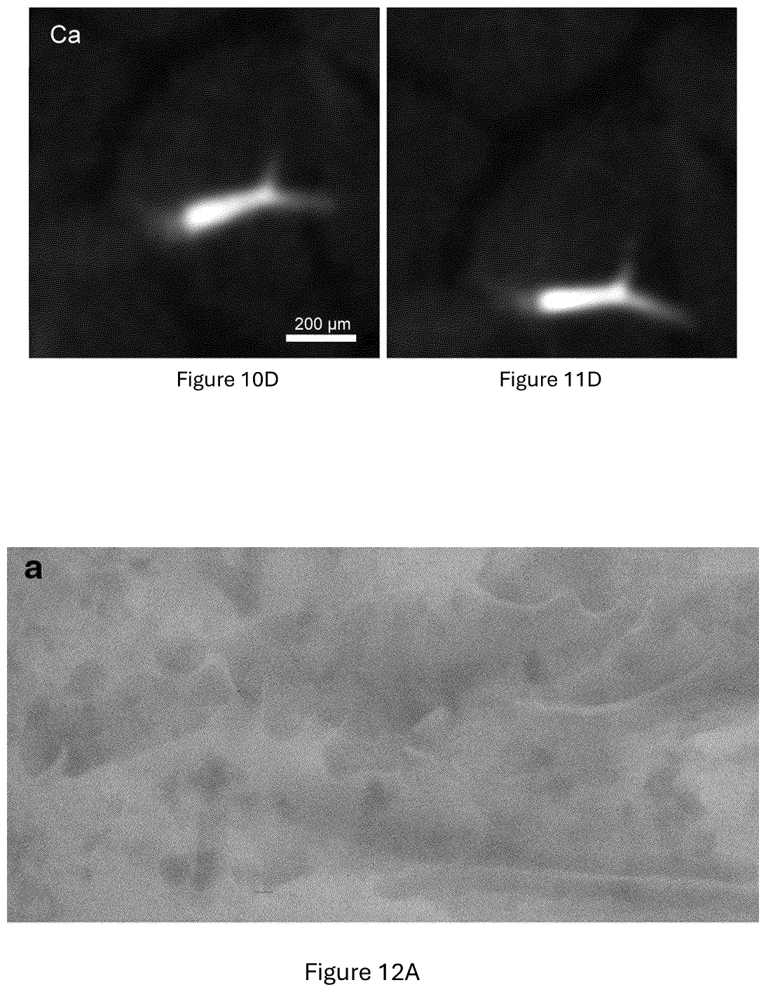

FIG. 11A shows an example of a second optical image of a leaf, FIG. 11B shows the result of utilizing a CA-Calcium wavelength to attenuate trace metals in the leaf, and FIG. 11C shows the result of using a Zn-Zinc wavelength to attenuate trace metals in the leaf.

FIG. 11D illustrates the spectral analysis image of 11B and the optical image of 11A wherein the spectral analysis image of 11B and the optical image of 11A are displayed overlaid.

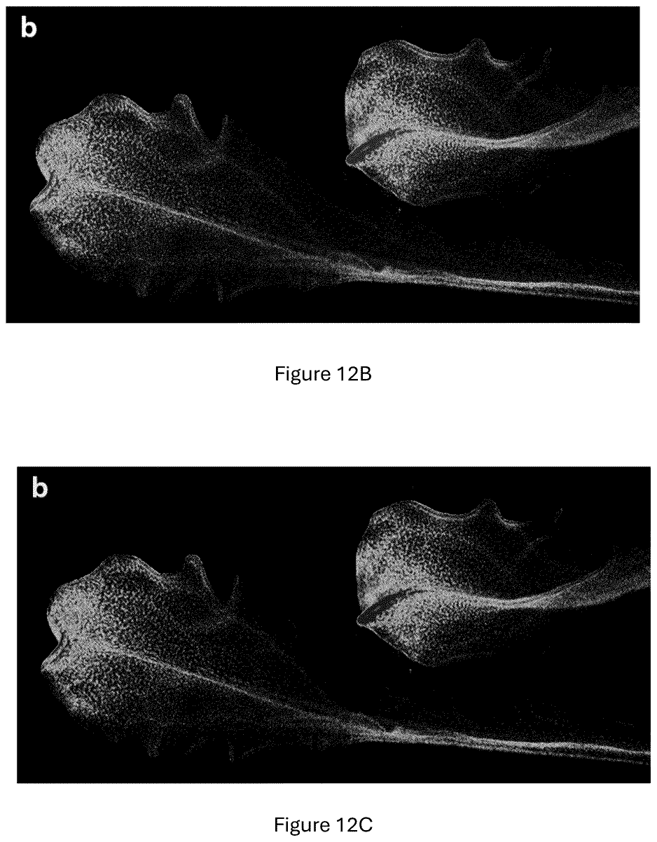

FIG. 12A shows an X-ray image;

FIG. 12B shows a color palate interpolation of the X-ray image; and

FIG. 12C shows a gray scale interpolation of the X-ray image.

For exemplary descriptive purposes, in a normal X-ray or spectral image (i.e., before the densities of the different area of the specimen are determined and an image produced therefrom), there can be five different densities that can be useful to determine the nature of an abnormality (e.g., air, fat, soft tissue, bone and metal). If there is an unexpected increase or decrease in the density of a known anatomical structure then this may help determine the tissue structure of the abnormality. Low density material such as air is represented as black on the normal X-ray or radiograph image. Very dense material such as metal or contrast material is represented as white. Bodily tissues are varying degrees of gray, depending on density, and thickness. Utilizing artificial intelligence and neural networks, the algorithm of embodiments of the present disclosure can take the varying degrees of gray of an X-ray image, as shown in FIG. 12A and interpolates them to a color palate as shown in FIG. 12B, or a gray scale as shown in FIG. 12C, where the different colors or shades of gray indicate different densities or a range of densities of areas of the specimen. Changes in color can be more easily perceived than changes in shades of gray of the initial X-ray image and therefore this procedure makes the interpretation and understanding of the image easier for a medical professional (e.g., surgeon or other medical doctor). During colorization, for example, the algorithm replaces a scalar value representing pixel's intensity with a vector in a given color space. Human interaction and external information usually plays a large role in evaluating the original X-ray image, where the evaluation is enhanced by the interpolation to a color palate as shown in FIG. 12B, or a gray scale as shown in FIG. 12C.

One embodiment of the present disclosure utilizes a controller or computer of embodiments of the present disclosure, for example a controller or computer 470, for example, as shown in FIG. 2, to control, manage, manipulate and analyze the image data obtained by the cabinet X-ray system or unit and other embodiments of the present disclosure in order to analyze the different densities of a specimen and assigning a color to each of those densities. One embodiment for obtaining and analyzing the different densities of a specimen and assigning a color to each of those densities includes beaming X-rays through tissue of a specimen and measuring their magnitude (i.e., intensity) after they have passed through the specimen utilizing an X-ray detector, for example, X-ray detector 20, the X-ray detector including, for example, a plurality of pixels including a two-dimensional array of pixels used to detect incoming X-rays emitted from an X-ray source, for example, X-ray source 10 of embodiments of the present disclosure. Some of the pixels will detect X-rays. Since denser materials like bone will attenuate (weaken the energy) the X-rays more than soft tissue does, their shape becomes clear as a flat, monochrome image in the colorized image embodiments of the present disclosure. The detector can measure the attenuation of specific wavelengths of the X-rays as they pass through different materials. One embodiment for generating an image, where the darkness of a gray scale denotes the density of different areas, or different colors denote the density of different areas, uses an algorithm to record the magnitude (i.e., intensity) of each pixel of the detector that is received by the detector and based on the magnitude (i.e., intensity) being emitted from the X-ray source, for example, X-ray source 10, determines the difference in magnitude between the source 10 and what is received by the detector 20. An algorithm, different or incorporated into other algorithms disclosed herein, can use that information on the difference from each pixel of the detector to produce an image whereby the quantity of the difference in magnitude (i.e., intensity), or a range of differences in magnitude (i.e., intensity) at each pixel I assigned a specific color, or shades of a color, or a gray scale level. An image may then be displayed of the specimen in those colors, shades of color or gray scale showing the different densities or range of densities of parts of the specimen. For example, after running the data through the specific algorithms, a color image can generated that shows muscle, bone, water, fat, disease markers so that their presence in the specimen can then be determined. That means two objects of similar density but different materials can be distinguished.

Another embodiment of the cabinet X-ray systems or units of the present disclosure can distinguish different material of the specimen by training or including an algorithm to analyze the system imaging the specimen using the same technique, while adjusting kVp and mA (the mA (tube current and exposure time product) and filtration, kVp (tube voltage), on the X-ray system to control the image quality and patient dose.

The algorithm could be calibrated and could record an ADU unit for each density/material in the specimen, and utilizing a table or other list in memory of information on the densities of different material, discern the different materials making up the specimen.

The detailed images of the embodiments of the present disclosure can be viewed in real-time and/or saved for future examination in various formats in the main computer 470 and then may be transmitted via USB, ethernet, Wi-Fi, etc. in various formats that may include DICOM, .tiff. or .jpeg, non-inclusive.

One embodiment of the cabinet X-ray system or unit of the present disclosure includes a controller or computer, for example a controller or computer 470 in FIG. 2 that includes a processing unit 102 as shown in FIG. 7, a x-ray fluorescence detector input 103 for collecting an X-ray fluorescence image of, for example, a sample or specimen, the X-ray fluorescence from a radiographic system as well as previous figures and disclosure included above and entered at an input of I/O 112 to the cabinet X-ray system or unit embodiments of the present disclosure. The processing unit 102 generally includes elements necessary for performing image processing including parallel processing steps of embodiments of the present disclosure. The specimen fluorescence may be one of a plurality of such fluorescences that can be used to produce spectral images. The colorizing of X-ray images or spectral images to indicate density or a range of densities is another use of the processing unit 102. In particular, the processing unit 102 includes elements such as a central control unit 105, a memory 108, a processor 110, and I/O (input/output) unit 112. The central control unit 105 performs the commands to manipulate the data. Memory 108 performs the temporary storage and manipulation of the data as well as storage of algorithms and other software used by the cabinet X-ray system or unit or other embodiments of the present disclosure in performing aspects of the embodiments, methods and systems included herein. Processor 110 performs and allows simultaneous calculating, and notation of all images as well as management and manipulation of the data utilizing algorithms and other software used by the cabinet X-ray system or unit or other embodiments of the present disclosure in performing aspects of the embodiments, methods and systems included herein. I/O (input/output) unit 112 performs control of the input data and the resulting output/display. It is to be appreciated that the processor 110 shown in FIG. 7 may be a parallel processor, a single processor, or multiple processors without departing from the scope of the preferred embodiments. It is to be appreciated that in addition to the image analysis and manipulation algorithms disclosed herein, processing unit 102 is capable of performing a multiplicity of other image processing algorithms either serially or in parallel therewith.

Display or monitor 472 (FIG. 2) is for conveniently viewing both images of embodiments of the present disclosure and the output of the processing unit 102 thereon. Display or monitor 472 may also include a user interface as user interface 476 exemplified in the embodiment of FIG. 2, such as a keyboard and mouse for example. In one embodiment. Display or monitor 472 can comprise a touch screen or near touch screen device separately or integrated as part thereof. Display or monitor 472 may be, for example, an LCD screen. As used herein, the term “display” or “monitor” means any type of device adapted to display information, including without limitation CRTs, LCDs, TFTs, plasma displays, LEDs, and fluorescent devices. Display or monitor 472 typically shows any of the images included in the embodiments of the present disclosure.

Indeed, it is appreciated that the system and its individual components can include additional features and components, though not disclosed herein, while still preserving the principles of the present disclosure. Note also that the base computer can be one of any number devices, including a desktop or laptop computer, etc.

Aspects of the present disclosure may be embodied in other specific forms without departing from its spirit or essential characteristics. The described embodiments are to be considered in all respects only as illustrative, not restrictive. All changes that come within the meaning and range of equivalency of the claims are to be embraced within their scope.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While there have been shown, described and pointed out, fundamental features of the present disclosure as applied to the exemplary embodiments thereof, it will be understood that various omissions and substitutions and changes in the form and details of compositions, devices and methods illustrated, and in their operation, may be made by those skilled in the art without departing from the spirit or scope of the present disclosure. Moreover, it is expressly intended that all combinations of those elements and/or method steps, which perform substantially the same function in substantially the same way to achieve the same results, are within the scope of the present disclosure. Moreover, it should be recognized that structures and/or elements and/or method steps shown and/or described in connection with any disclosed form or embodiment of the present disclosure may be incorporated in any other disclosed or described or suggested form or embodiment as a general matter of design choice. It is the intention, therefore, to be limited only as indicated by the scope of the claims appended hereto.

What is claimed is:

1. A cabinet x-ray image system for obtaining x-ray fluorescence images of a specimen or sample, the system comprising:
a cabinet defining an interior chamber wherein the cabinet comprises a walled enclosure surrounding the interior chamber, a door configured to cover the interior chamber and a sampling chamber for containing the specimen;
a display;
an x-ray fluorescence system including:
an x-ray source;
a crystal;
focusing coils or collimators;
a fluorescence detector; and
a specimen platform; and
a controller configured to:
selectively energize the x-ray source to emit x-rays through the specimen to the crystal and then through the focusing coils or collimators to the x-ray fluorescence detector;
control the x-ray fluorescence detector to collect a spectra of the specimen when the x-ray source is energized; and
control the focusing coils or collimators;

2. The cabinet x-ray image system of claim 1, wherein the x-ray source comprises a conventional, mini-focus, or micro-focus x-ray source.

3. The cabinet x-ray image system of claim 1, wherein the detector comprises anything that fits within the confines of the cabinet;

4. The cabinet x-ray image system of claim 1, wherein the specimen platform is configured to hold excised tissue, organ or bone specimens.

5. The cabinet x-ray image system of claim 1, wherein the specimen platform is configured hold any organic or inorganic specimen or sample.

6. The cabinet x-ray image system of claim 1, wherein the cabinet x-ray image system further includes:
an optical camera configured to capture an optical image of the specimen; and
the controller is further configured to:
control the optical camera system to capture and collect the optical image of the specimen; and
selectively display a spectral analysis image and an optical image of the specimen on the display.

7. The cabinet x-ray image system of claim 6, wherein the spectral analysis image and the optical image of the specimen are displayed overlaid.

8. The cabinet x-ray image system of claim 1, wherein:
the x-ray source is configured to emit a first amount of x-rays;
the x-ray detector includes a plurality of pixels in an array, each pixel configured to detect a second amount of x-rays received by the pixel; and
the controller is further configured to:
create the density x-ray image from the plurality of pixels by comparing from the first amount of x-rays and the second amount of x-rays for each pixel in the array.

9. The cabinet x-ray image system of claim 1, wherein the different areas of the specimen or sample of the spectral x-ray image are displayed in different grey scale, different color or different shades of color.

10. A method for obtaining x-ray images and colorized or grey scale density x-ray images of a specimen using a cabinet x-ray image system, wherein the cabinet x-ray image system comprises:
a cabinet defining an interior chamber wherein the cabinet comprises a walled enclosure surrounding the interior chamber, a door configured to cover the interior chamber and a sampling chamber for containing the specimen;
a display;
an x-ray system including:
an x-ray source;
a photon-counting detector; and
a specimen platform; and
a controller
wherein the method comprises using the controller to:
selectively energize the x-ray source to emit x-rays through the specimen to the x-ray detector;
control the x-ray detector to collect a projection x-ray image of the specimen when the x-ray source is energized;
determine the density of different areas of the specimen from data collected from the x-ray detector of the projection x-ray image of the specimen when the x-ray source is energized;
create a density x-ray image of the specimen wherein the different areas of the specimen are indicated as a density or range of densities based on the determined density of different areas of the specimen; and
selectively display the density x-ray image of the specimen on the display.

11. The method of claim 10, wherein the cabinet x-ray image system further includes:
an optical camera configured to capture an optical image of the specimen; and
the method further comprising using the controller to:
control the optical camera system to capture and collect the optical image of the specimen; and
selectively display the density x-ray image and the optical image of the specimen on the display.

12. The method of claim 10, wherein the spectral x-ray image and the optical image of the specimen are displayed overlaid.
